(19) United States
(12) Patent Application Publication
(10) Pub. No.: US 2024/0181699 A1
(43) Pub. Date: Jun. 6, 2024

(54) SYSTEMS AND METHODS FOR MICROWAVE ADDITIVE MANUFACTURING

(71) Applicant: Lawrence Livermore National Security, LLC, Livermore (CA)

(72) Inventors: Johanna Jesse SCHWARTZ, Livermore, CA (US); Saptarshi MUKHERJEE, Milpitas, CA (US); Emeraldo V. BALUYOT, Mountain House, CA (US)

(21) Appl. No.: 18/075,947

(22) Filed: Dec. 6, 2022

(51) Int. Cl. B29C 64/264; B29C 64/232; B29C 64/236; B29C 64/393

(52) U.S. Cl. CPC B29C 64/264; B29C 64/232; B29C 64/236; B29C 64/393; B33Y 30/00

(57) ABSTRACT

The present disclosure relates to systems and methods for using microwave energy in various additive manufacturing (“AM”) processes to make a part. In one embodiment a system is disclosed having an electronic controller, a microwave energy generator subsystem responsive to the electronic controller for generating a microwave energy signal, and a beam patterning component for patterning the microwave energy signal into a microwave beam having a desired spatial energy distribution profile for at least one of curing or sintering a feedstock material being used to form a part. The beam pattering component in one implementation is movable relative to the feedstock material, and within an X axis and Y axis plane.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to additive manufacturing systems and methods, and more particularly to additive manufacturing systems and methods that employ microwave energy for curing, sintering, or binding of a thermally-sensitive feedstock material.

### BACKGROUND

The statements in this section merely provide background information related to the present disclosure and may not constitute prior art.

Recent years have seen rapid advancements in advanced manufacturing techniques. An advanced volumetric additive manufacturing (VAM) technique that relies on rotating a photosensitive resin in a dynamically evolving light field has been recently developed (see, e.g., Kelly, B. E., Bhattacharya, I., Heidari, H., Shusteff, M., Spadaccini, C. M. and Taylor, H. K., 2019. Volumetric additive manufacturing via tomographic reconstruction. Science, 363(6431), pp. 1075-1079); Shusteff, M., Browar, A. E., Kelly, B. E., Henriksson, J., Weisgraber, T. H., Panas, R. M., Fang, N. X. and Spadaccini, C. M., 2017. One-step volumetric additive manufacturing of complex polymer structures. Science advances, 3(12), p.eaao5496).

Unlike most AM processes that print point-by-point voxels serially to build up the 3D volume such as fused deposition modeling or ink-jetting, the biggest advantage of this approach is the capability to print arbitrarily defined 3D geometries as a unit operation, with no substrate or support structures required. However, the current technique is limited to transparent photosensitive liquid resins due to the high attenuation of light waves in optically opaque materials. Techniques which extend the material space to include translucent and opaque materials will enable VAM to be more broadly used for all material types. This could include particle additives such as piezoresistive and conductive carbon black, modulus-strengthening ceramics, and chemically active inorganic catalysts. In addition, microwave-assisted VAM could also access resin chemistries that are not currently possible through photo-mediated VAM polymerization mechanisms such as step-growth polymerizations of polyamides, ring-opening polymerizations of polycaprolactone, and controlled free-radical polymerizations (see, Kumar, A., Kuang, Y., Liang, Z. and Sun, X., 2020. Microwave chemistry, recent advancements and eco-friendly microwave-assisted synthesis of nanoarchitectures and their applications: A review. Materials Today Nano, p. 100076).

While microwave curing has been deployed for polymer curing, the techniques have primarily been used for the bulk curing of polymer samples. However, the results indicate promise for the utility of a microwave-based approach for VAM. Prior work using microwave heating of epoxy resins using a conventional microwave oven has shown faster curing times and better mechanical properties than thermal heating (see, e.g., Boey, F. Y. C. and Yap, B. H., 2001. Microwave curing of an epoxy-amine system: effect of curing agent on the glass-transition temperature. Polymer testing, 20(8), pp. 837-845; Tanrattanakul, V. and SaeTiaw, K., 2005. Comparison of microwave and thermal cure of epoxy-anhydride resins: Mechanical properties and dynamic characteristics. Journal of Applied Polymer Science, 97(4), pp. 1442-1461), less dimension variations, and more cost-effectiveness in comparison to ultraviolet chamber curing (see e.g., Zhao, J., Yang, Y. and Li, L., 2020. A comprehensive evaluation for different post-curing methods used in stereolithography additive manufacturing. Journal of Manufacturing Processes, 56. pp. 867-877). In contrast to X-ray based heating, the ability of microwave energy to penetrate through thick, optically opaque materials and produce rapid (<1 min), intense volumetric heating (kW), with large sample area coverages (meters) makes it an ideal candidate (see, e.g., Sweeney, C. B., Lackey, B. A., Pospisil, M. J., Achee, T. C., Hicks, V. K., Moran, A. G., Teipel, B. R., Saed, M. A. and Green, M. J., 2017. Welding of 3D-printed carbon nanotube-polymer composites by locally induced microwave heating. Science advances, 3(6), p. e1700262). Rapid curing of polymer thermoset systems using scanned microwave heating of carbon nanotube/epoxy composites has been achieved in prior system (see, e.g., Odom, M. G., Sweeney, C. B., Parviz, D., Sill, L. P., Saed, M. A. and Green, M. J., 2017. Rapid curing and additive manufacturing of thermoset systems using scanning microwave heating of carbon nanotube/epoxy composites. Carbon, 120, pp. 447-453).

Initial simulation studies on shaping microwave beams using a single microwave applicator for ceramics are promising but lack a computational model for optimizing the microwave absorption rates and require inverse design of the applicator geometry for each new part to generate different beam shapes corresponding to different geometries (see, e.g., Iliopoulos, A. P., Michopoulos, J. G., Steuben, J. C., Birnbaum, A. J., Graber, B. D., Rock, BY., Johnson, L. A. and Gorzkowski, E. P., 2019, August. Towards Selective Volumetric Additive Manufacturing and Processing of Ceramics. In International Design Engineering Technical Conferences and Computers and Information in Engineering Conference (Vol. 59179, p. V001T02A036). American Society of Mechanical Engineers).

Accordingly, a need still exists for systems and methods that are able to highly controllably localize, within a 2D plane or within a 3D volume, microwave energy being projected toward a feedstock material, so as to be able to cure or sinter the feedstock material as needed to form a desired part. In addition to localization of microwave energy, the localization of heat within the system can enable selective thermally-mediated chemistries and processes such as curing, sintering, and binding of feedstock materials. Unlike photo-based systems, which require light penetration and thereby optical transparency or translucency, microwave-based systems may be optically opaque or highly light scattering, accessing a much broader range of feedstock materials. These material feedstocks can include liquids, gels, pastes, composites, and solids such as ceramics, glass, carbon, and conductive materials like metals. Penetration in microwave systems, is dependent on the dielectric of the material, with a tradeoff in power and resolution for high dielectric materials.

### SUMMARY

This section provides a general summary of the disclosure, and is not a comprehensive disclosure of its full scope or all of its features.

In one aspect the present disclosure relates to a microwave additive manufacturing system. The system may comprise an electronic controller, a microwave energy generator subsystem responsive to the electronic controller for generating a microwave energy signal, and a beam patterning component. The beam patterning component maybe configured to pattern the microwave energy signal into a microwave beam having a desired spatial energy distribution profile for at least one of curing or sintering a feedstock material being used to form a part. The beam patterning component is movable relative to the feedstock material, and within an X axis and Y axis plane.

In another aspect the present disclosure relates to a microwave additive manufacturing system. The system may comprise an electronic controller, a microwave energy generator subsystem responsive to the electronic controller for generating a microwave energy signal, and a beam patterning component. The beam patterning component may be configured to pattern the microwave energy signal into a microwave beam having at least a desired 2D spatial energy distribution profile for at least one of curing or sintering a feedstock material being used to form a part. A motion gantry may be included for moving the beam patterning component along at least one axis while the curing or the sintering of the feedstock material is occurring.

In still another aspect the present disclosure relates to a method for additively manufacturing a part. The method may comprise obtaining part data which defines features or characteristics of a part to be manufactured. The method may further include obtaining data relating to a characteristic of a feedstock material to be used to form the part and generating a microwave energy signal. The method may further include using the part data and the data relating to the characteristic of the feedstock material to pattern the microwave energy signal to form a patterned microwave energy beam signal with a desired spatial energy distribution profile able to at least one of cure or sinter the feedstock material. The method may further include directing the patterned microwave energy beam signal at the feedstock material for a time sufficient to at least one of cure or sinter the feedstock material to form the part.

In still another aspect the present disclosure relates to a microwave additive manufacturing system. The system may comprise comprising an electronic controller, a microwave energy generator subsystem responsive to the electronic controller for generating a microwave energy signal, and a stationary beam patterning component. The stationary beam pattering component may be configured to pattern the microwave energy signal into a microwave beam having a desired spatial energy distribution profile for at least one of curing or sintering a feedstock material being used to form a part. The stationary beam pattering component may be elevationally aligned with, and spaced apart from, the feedstock material.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

Corresponding reference numerals indicate corresponding parts throughout the several views of the drawings in which:

FIG. 1 is a high level block diagram of one embodiment of a system in accordance with the present disclosure which makes use of a controllably movable gantry, movable within an X/Y plane, for curing a feedstock material such as a thermally sensitive resin or ink in a Direct Ink Write additive manufacturing operation;

FIG. 2 is a high level block diagram of another embodiment of a system in accordance with the present disclosure which makes use of an engineered RF reflecting surface component which is able to cure, virtually immediately, a feedstock as the feedstock is extruded onto a build plate;

FIG. 3 is a high level block diagram of another embodiment of a system in accordance with the present disclosure which makes use of a digitally controllable mask for 2D or 3D spatial patterning of a microwave energy beam; and

FIG. 4 is a high level flowchart of one example of various operations that may be performed by the embodiments described herein in manufacturing a part using microwave energy.

### DETAILED DESCRIPTION

Example embodiments will now be described more fully with reference to the accompanying drawings.

The present disclosure relates to additive manufacturing (“AM”) systems and methods that uses microwave energy to controllably cure a feedstock material being used to make a part. Unlike photo-based AM methods, microwaves have the significant advantage of being able to penetrate opaque composite mixtures and achieve thermal curing. This significantly expands the range of materials and chemistries accessible to AM processes. The various embodiments and methods described are able to selectively localize the microwave field for each one of a plurality of different AM processes, for example single dimensional microwave field localization for a Direct Ink Write (“DIW”) AM process, two dimensional layer microwave field localization for a stereolithographic AM process, and even three dimensional microwave field localization for curing or sintering full objects in a single operation with a 3D volumetric AM process.

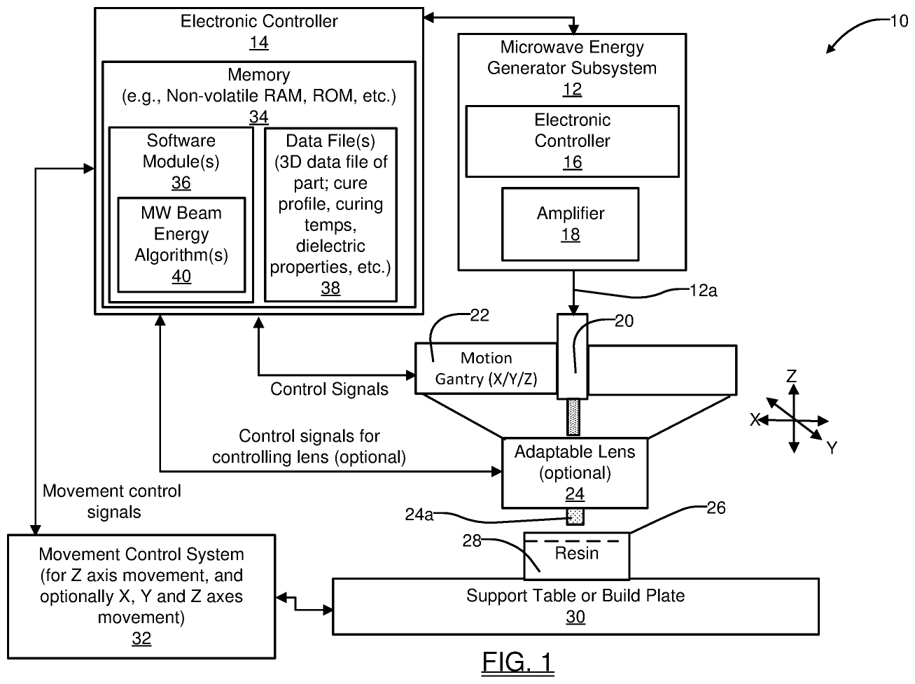

Referring to FIG. 1, a system 10 is shown in accordance with one embodiment of the present disclosure. The system 10 in this example includes a microwave energy generator subsystem (“MEGS”) 12 which communicates with, and may be controlled by, an electronic controller 14. The MEGS 12 may include its own electronic controller 16 as well as an amplifier 18 for amplifying a microwave energy output signal 12a output from the MEGS 12. The output signal 12a is input to a waveguide applicator 20 (e.g., coaxial cable or other waveguide component) which is supported by a motion gantry 22 capable of moving along X, Y and Z axes, and which may be controlled by the electronic controller 14. The waveguide applicator 20 forms an interface between the MEGS 12 and an adaptable lens 24, and radiates the microwave energy signal 12a output from the MEGS 12 into an input side of the adaptable lens. The adaptable lens 24 forms a microwave energy beam patterning component which may optionally be of a construction which has one or more optical characteristics (e.g., polarization) which may be controlled by suitable electrical control signals from the electronic controller 14, or it may be an element with fixed optical characteristics. In either case, the adaptable lens 24 produces a patterned microwave energy beam 24a which is directed into a feedstock material used in an AM process, for example a composite, thermally responsive resin 28, held within a container 26, which is being used to make a part. The microwave energy beam 24a is precisely patterned such that it only causes curing of those portions of the resin 28 which it impinges.

Movement of the motion gantry 22 allows the waveguide applicator 20 and the adaptable lens 24 to be scanned in X and Y directions, or in X, Y and Z directions, as needed, such that the microwave energy beam 24a selectively cures portions of the resin 28 to form a layer of the part. A movement control subsystem 32 may be used to control Z axis movement of the support table or build plate 30, if needed, and optionally X axis and Y axis movement of the support table or build plate. However, it is expected that in most implementations, either the motion gantry 22 or the movement control subsystem 32 will be used, but not both. The system 10 thus forms a Direct Ink Write AM system.

The electronic controller 14 may include a non-volatile memory 34 (e.g., RAM, ROM, DRAM, etc.) for storing one or more software modules 36 as well as various data files 38. The software modules 36 may include one or more algorithms or executable programs for calculating or determining the microwave energy beam profile to be used for a specific 3D part (or layer of a part) made from a specific feedstock material, or for performing any calculations needed to control a typical AM process. Such calculations may be performed in real time to modify the microwave energy distribution profile of the microwave energy output signal 12a generated by the MEGS 12 as needed, either during curing or sintering of a single layer of a part, or during curing or sintering of a volume of feedstock material.

The data files 38 may include one or more files including, but not limited to, 3D part data files needed to form each layer of a complete 3D part, or characteristics of various feedstock materials. Such characteristics may include curing temperature profiles for specific thermo-responsive feedstock materials, dielectric properties for different feedstock materials, look-up tables correlating cure times and different microwave energy power levels to be used for different feedstock materials, as well as any other information that may be helpful or required to carry out an AM process.

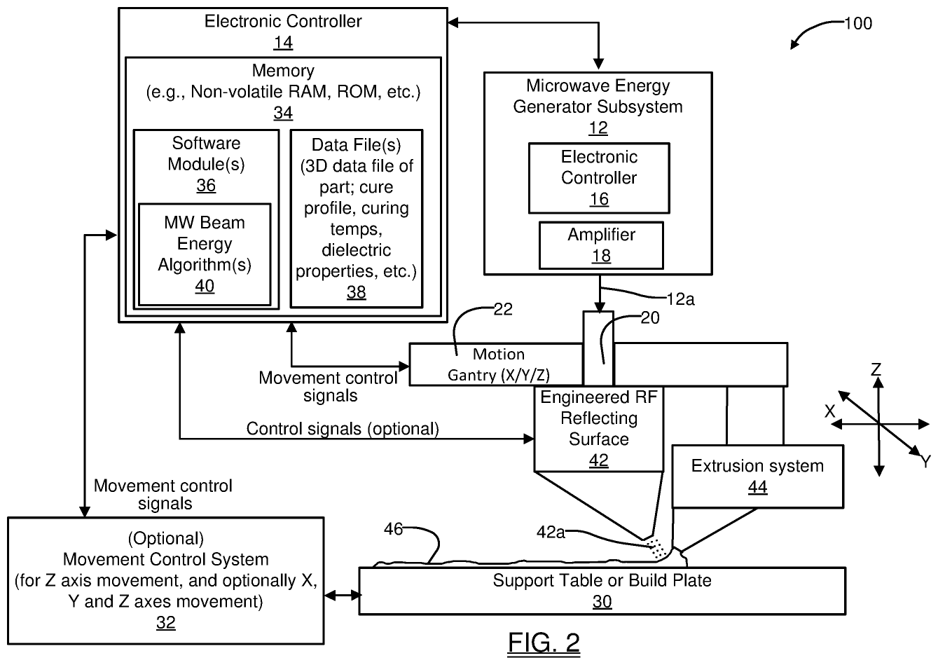

FIG. 2 shows a system 100 in accordance with another embodiment of the present disclosure which is similar to the system 10, but which is configured to perform sintering of an extruded thermally responsive paste 46. Components in common with the system 10 have thus been designated with the same reference numbers used in FIG. 1. The system 100 differs from the system 10 in that it includes an engineered RF reflecting surface component 42 which acts as the microwave energy beam patterning component. The engineered RF reflecting surface component 42 focuses or patterns a microwave energy beam 42a as needed to virtually immediately cure or sinter the extruded thermally responsive resin or paste 46, which is being deposited by an extrusion system 44. The thermally-responsive resin or paste 46 may be comprised of monomers, polymers, polymer composite, or alternatively may comprise a resin or paste made at least in part (or entirely) of ceramic, metal or glass, or any other thermally responsive material including thermosets and thermoplastics. These materials may also include reactive or responsive components including catalysts, thermally-deprotectable monomers or reagents, and thermally or microwave-degradable sacrificial additives, such as polymers, capsules, or particles. (The engineered RF reflecting surface component 42 may be responsible for generating electric fields to create a spatial beam pattern, for example a 2D or 3D beam pattern having a 2D or 3D spatially varying electromagnetic wave intensity, which is needed to cure or sinter the thermally responsive resin or paste 46 as needed to form a specific part. The engineered RF reflecting surface component 42 essentially creates a mask that is used to pattern the microwave energy which is being radiated into the thermally responsive paste 46 into a desired 2D or 3D shape and size. The engineered RF reflecting surface component 42 may be designed using different techniques such as graded dielectric properties, metal structures with discontinuities or programmable metasurfaces. The thickness and spatial dimensions of the engineered RF reflecting surface component 42 may be varied as needed to deposit microwave energy at varying distances away from the surface of the support table or build plate 30. The engineered RF reflecting surface component 42 may therefore be used in processes involving a layer-by-layer manufacturing process, as well as a continuous printing/curing/sintering process, as well as a process similar to a stereolithographic printing process or a 3D volumetric AM printing process.

With the system 100, the extrusion system 44 may be physically coupled to the motion gantry 22, such that movement of the engineered RF reflecting surface component 42, and the microwave energy beam 42a it emits, move together in perfect registration with the extrusion system 44. Optionally, the extrusion system 44 may be moved by a separate motion control system (not shown) which is synchronized in operation to the motion gantry 22. In either case, the extruded, thermally responsive paste 46 may be laid down in any needed linear or non-linear path, that is, either along one axis, or along a path that travels along both X and Y axes, and the microwave energy beam 42a will virtually immediately cure or sinter the resin or paste 46 as it is laid down. Still further, the support or build table 30 may be moved as needed along one or both of the X and Y axes, while the engineered RF reflecting surface component 42 and the extrusion system 44 are held stationary. Still further, it is possible that the engineered RF reflecting surface component 42 may be dithered slightly laterally back and forth while travelling along its principal direction of movement, such that it still follows the path of movement of the extrusion system 44, and still cures or sinters the thermally-responsive resin or paste 46 virtually immediately as the resin or paste is laid down.

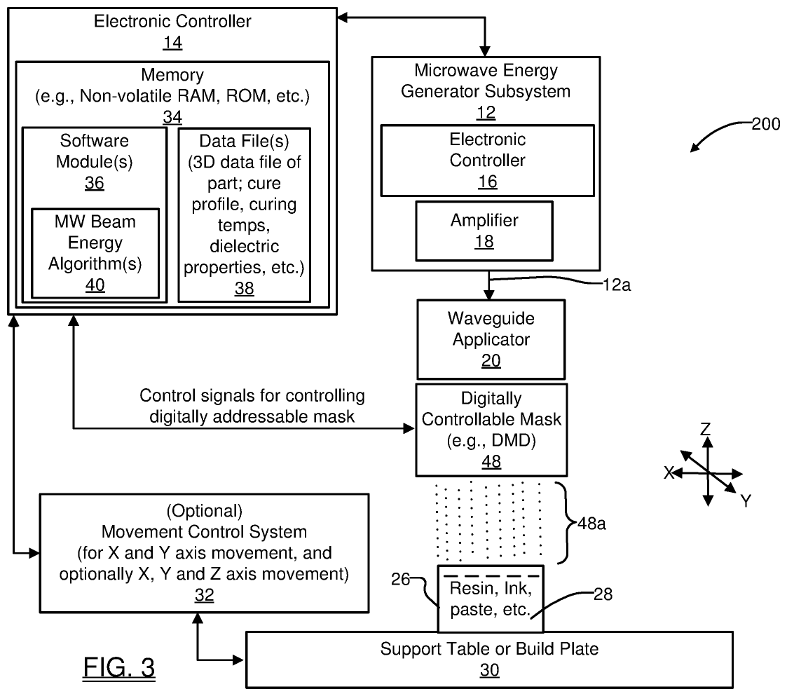

Referring now to FIG. 3, a system 200 in accordance with another embodiment of the present disclosure is shown. The system 200 is similar to the system 10, and components in common with system 10 have been designated with common reference numbers in FIG. 3. The system 200 differs from systems 10 and 100 in that it makes use of a digitally controllable mask 48. The mask 48 in one implementation (i.e., as shown in FIG. 3) is stationary relative to the build plate 30 and the container 26, and spaced apart elevationally and over the container 26 along the Z axis. The mask 48 in one implementation may form a digital micromirror device (“DMD”) or functionally equivalent system, which acts as a microwave energy beam patterning component. A DMD typically includes a large plurality, often tens of thousands or more, individually electrically addressable micromirrors that can be controlled to create a mask for patterning electromagnetic wave energy. The digital mask can be realized utilizing a reprogrammable hologram based on 1-bit coding metasurface arrays. The state of each unit cell of the coding metasurface can be switched between ‘1’ and ‘0’ by electrically controlling the phase response of the unit cells using diode circuits. Such devices are commercially available from Texas Instruments, Inc., as well as other manufacturers. In this embodiment the digitally controllable mask 48 is controlled using control signals from the electronic controller 14, although it is also possible to use a separate, dedicated controller with the digitally controllable mask that communicates with the electronic controller 14. The digitally controllable mask 48 creates a spatially patterned 2D electromagnetic wave signal 48a that is able to cure or sinter a 2D layer of feedstock material, or even a 3D volume of feedstock material, in a single operation, without physical movement of the mask or the support table or build plate 30. However, an optional configuration may include the movement control system 32 to provide relative movement between the mask 48 and the feedstock material being cured or sintered by the system 200.

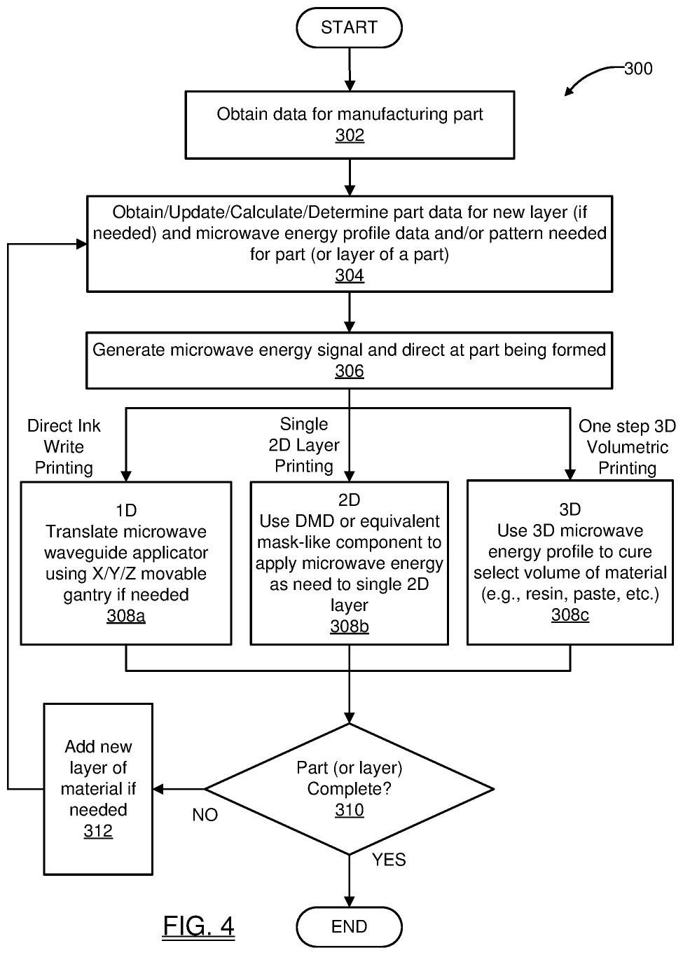

Referring now to FIG. 4, a high level flowchart 300 is shown illustrating one example of various operations that may be performed using one or more of the systems 10, 100 or 200. At operation 302 the manufacturing data needed to form a part, or a layer of a part, is obtained by the electronic controller 14. At operation 304 the electronic controller 14 determines, from stored information in the data files 38, and optionally using one or more microwave beam energy algorithms 40, a spatial microwave energy pattern needed for forming the part, or at least a layer or portion of the part. At operation 306 the MEGS 12 uses the information provided by the electronic controller 14 to generate the microwave energy output signal 12a, which is then spatially patterned as needed (i.e., spatially patterned with a 2D intensity pattern or 3D volumetric energy distribution profile) to form the part, or at least a layer or portion of the part. If a DIW AM process is being carried out, then operation 308a will be performed to translate one or the other of the microwave waveguide applicator 20 or the support table or build plate 30, as needed to carry out the printing operation. If a 2D AM printing operation is being carried out, such as with the system 200 in printing a single layer of a part, then operation 308b will be carried out. This involves using the digitally controllable mask 48 to pattern the microwave energy signal 48a received from the MEGS 12 as needed to cure or sinter a single 2D layer of the part. If a 3D volumetric AM process is being used, such as with the system 100, then either the engineered RF reflecting surface component 42 of system 100 or the digitally controllable mask 48 of system 200 may be used to produce the 3D microwave energy profile needed to cure or sinter the part in a single operation, as indicated at operation 308c.

At operation 310 the electronic controller 14 may make a check, using its stored 3D part data from the data file 38, to determine if the part, or a layer of the part, is complete. If this answer is “YES”, then the manufacturing operation is complete. If “NO”, then a new layer of material may be added onto a just-cured or just-sintered layer, if needed, and operations 302-310 repeated until the part is complete.

Unlike prior art AM systems, the various systems and methods described herein directly cure thermoset materials using patterned microwave energy. This has a number of important advantages over optical-based AM systems. With the present systems and methods, the resin chemistries, composite additives, and temperatures necessary for curing can be rapidly adjusted in real time while the manufacturing process is being carried out, for example either during the printing of a layer of a part, or between prints of layers, depending on the configuration of the part. The use of microwave energy to cure or sinter the feedstock material provides an especially important advantage in that microwave energy is able to access (i.e., be projected into) opaque, composite, solids-only, solids-laden, and thermal chemistry formulations that would otherwise not be usable in photo-based AM methods. The use of microwave energy to cure or sinter the feedstock material enables a wide range of materials such as, but not limited to, ceramics and various metals, to be used as the feedstock material in forming a part.

The teachings presented herein are expected to find utility not just in AM processes, but also in forming electronically sensitive structures and the processing of granular feedstock including glass and ceramic materials. These materials can be utilized in applications including damping, aerospace, surgical equipment, microfluidics, and optics. Specific implementations are expected to include electronically sensitive structures which may include electromagnetic absorbers, embedded wireless electronics, as well as tunable metamaterials.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A microwave additive manufacturing system comprising:
an electronic controller;
a microwave energy generator subsystem responsive to the electronic controller for generating a microwave energy signal;
a beam patterning component for pattering the microwave energy signal into a microwave beam having a desired spatial energy distribution profile for at least one of curing or sintering a feedstock material being used to form a part; and
the beam patterning component being movable relative to the feedstock material, and within an X axis and Y axis plane.

2. The system of claim 1, wherein the beam patterning component forms an adaptable lens.

3. The system of claim 1, wherein the beam patterning component comprises an engineered RF reflecting surface component.

4. The system of claim 1, further comprising a waveguide applicator for interfacing the microwave energy signal to the beam pattering component.

5. The system of claim 1, further comprising a motion gantry for moving the beam patterning component relative to at least one of a support table or a build plate on which the feedstock material is present.

6. The system of claim 5, wherein the motion gantry is movable.

7. The system of claim 6, wherein the motion gantry is movable in at least one of:
both of X axis and Y axis directions of movement; or
within each one of perpendicular X axis, Y axis and Z axis directions of movement.

8. The system of claim 1, further comprising a memory operably associated with the electronic controller for storing at least one software module used for determining a microwave beam energy profile required for forming at least one of a layer of the part, or an entirety of the part.

9. The system of claim 1, further comprising a memory operably associated with the electronic controller for storing one or more data files including at least one of:
3D part information needed for forming the part; or
a curing or sintering profile needed for curing or sintering a layer of the part of an entirety of a volume of material being used to form the part; or
a dielectric property or one or more feedstock materials being used to make the part.

10. The system of claim 1, wherein the microwave energy generator subsystem includes an amplifier for amplifying the microwave energy signal.

11. The system of claim 1, further comprising:
a support table or build plate;
an extrusion system supported for movement within an X/Y plane for extruding the feedstock material onto the support table or build plate, wherein the feedstock material comprises a thermally-responsive paste;
a movement subsystem for moving at least one of the beam patterning component or the support table or build plate, relative to the other; and
wherein the beam patterning component includes an engineered RF reflecting surface component configured to track movement of the extrusion system and to cure or sinter the thermally responsive paste as the thermally-responsive paste is laid down on the support table or build plate.

12. The system of claim 11, wherein:
the movement subsystem comprises a motion gantry movable along at least one axis of movement; and
the beam patterning component and the engineered RF reflecting surface are both operatively supported from and moved concurrently by the motion gantry.

13. A microwave additive manufacturing system comprising:
an electronic controller;
a microwave energy generator subsystem responsive to the electronic controller for generating a microwave energy signal;
a beam patterning component for pattering the microwave energy signal into a microwave beam having at least a desired 2D spatial energy distribution profile for at least one of curing or sintering a feedstock material being used to form a part; and
a motion gantry for moving the beam patterning component along at least one axis while the curing or the sintering of the feedstock material is occurring.

14. The system of claim 13, further comprising a waveguide applicator for interfacing the microwave energy signal to the beam pattering component.

15. The system of claim 13, wherein the beam pattering component comprises an adaptable lens.

16. The system of claim 13, wherein the beam patterning component comprises an engineered RF reflecting surface component.

17. The system of claim 13, further comprising a memory for storing at least one of:
at least one software module used for determining a microwave beam energy profile required for forming at least one of a layer of the part, or an entirety of the part; or
at least one data file including at least one of:
3D part information needed for forming the part; or
a curing or sintering profile needed for curing or sintering a layer of the part of an entirety of a volume of the feedstock material being used to form the part; or
a dielectric property of the feedstock material being used to make the part.

18. A method for additively manufacturing a part, comprising:
obtaining part data which defines features or characteristics of a part to be manufactured;
obtaining data relating to a characteristic of a feedstock material to be used to form the part;
generating a microwave energy signal;
using the part data and the data relating to the characteristic of the feedstock material to pattern the microwave energy signal to form a patterned microwave energy beam signal with a desired spatial energy distribution profile able to at least one of cure or sinter the feedstock material; and
directing the patterned microwave energy beam signal at the feedstock material for a time sufficient to at least one of cure or sinter the feedstock material to form the part.

19. A microwave additive manufacturing system comprising:
an electronic controller;
a microwave energy generator subsystem responsive to the electronic controller for generating a microwave energy signal;
a stationary beam patterning component for patterning the microwave energy signal into a microwave beam having a desired spatial energy distribution profile for at least one of curing or sintering a feedstock material being used to form a part; and
the stationary beam patterning component being elevationally aligned with, and spaced apart from, the feedstock material.

20. The system of claim 19, wherein the beam patterning component comprises a digitally controllable micromirror device.
